(19) United States
(12) Patent Application Publication
(10) Pub. No.: US 2024/0274983 A1
(43) Pub. Date: Aug. 15, 2024

(54) COMPOSITE CATHODE FRAME ASSEMBLY, BATTERY CORE AND ASSEMBLY METHOD OF THE BATTERY CORE

(71) Applicant: ZHEJIANG NARADA POWER SOURCE CO., LTD., Hangzhou (CN)

(72) Inventors: Yinglai WANG, Hangzhou (CN); Xinrui ZHANG, Hangzhou (CN); Xiangdang CHEN, Hangzhou (CN); Yanhong LI, Hangzhou (CN); Wen HUANG, Hangzhou (CN); Ling FANG, Hangzhou (CN); Liukou XU, Hangzhou (CN); Shuting WEN, Hangzhou (CN); Qinxu JIANG, Hangzhou (CN); Huayan CAO, Hangzhou (CN); Jiayuan XIANG, Hangzhou (CN); Feng GUO, Hangzhou (CN)

(73) Assignee: ZHEJIANG NARADA POWER SOURCE CO., LTD., Hangzhou (CN)

(21) Appl. No.: 18/424,189

(22) Filed: Jan. 26, 2024

Related U.S. Application Data
(63) Continuation of application No. PCT/CN2023/075131, filed on Feb. 9, 2023.

(51) Int. Cl. H01M 50/477; H01M 10/04; H01M 50/103; H01M 50/46

(52) U.S. Cl. CPC H01M 50/477; H01M 10/049; H01M 50/103; H01M 50/46

(57) ABSTRACT

The disclosure relates to a composite cathode frame assembly, a battery cell and an assembly method of the battery cell. The composite cathode frame assembly includes a frame, a cathode sheet and a separator sheet. An accommodating groove for embedding the cathode sheet is provided in the frame, both surfaces of the frame are matched with the separator sheet, and the separator sheet is attached to a surface of the frame and covers the cathode sheet and the frame. The battery cell includes the composite cathode frame assembly, a sleeve and an anode sheet. This disclosure has effect of reducing difficulty of manufacturing a battery cell on a premise of satisfying the battery cell overhang requirement.

### CROSS REFERENCE TO RELATED APPLICATION

The present application claims priority to International Application No. PCT/CN2023/075131, filed on 9 Feb. 2023, which is hereby incorporated herein by reference in its entirety.

### TECHNICAL FIELD

The disclosure relates to the field of batteries, in particular to a composite cathode frame assembly, a battery cell and an assembly method of the battery cell.

### BACKGROUND ART

A secondary battery, also known as a rechargeable battery or storage battery, refers to a battery that can be used continuously after being discharged by activating active materials in a charging manner.

A battery cell of the secondary battery is generally formed in a winding manner, with cathode and anode sheets being laminated and wound layer by layer with an entire continuous separator. In order to ensure safety of the battery, a size of the anode sheet can be larger than that of the cathode sheet, and the anode sheet should completely cover the cathode sheet in size and is beyond the cathode sheet at any of its edges, which is called “overhang”. Moreover, size difference between the anode and cathode sheets is very small, and a periphery of an anode can only be beyond by about 1 mm after the “overhang” is realized.

In this way, it is necessary to use a high-precision CCD alignment and rectification apparatus to ensure accurate control of a size of the anode over a cathode. A CCD is a visual sensor or an image sensor, which not only has high apparatus investment cost, but also greatly limits a speed of lamination and winding, and needs frequent debugging to maintain accuracy. Otherwise, with little carelessness, once the anode can't completely cover the cathode or even the cathode covers the anode for a size of the “overhang”, there may be lithium dendrite edge accumulation during cycles, which may affect safety of the battery and lead to a major safety accident.

### SUMMARY

In order to reduce difficulty of manufacturing a battery cell on a premise of satisfying the battery cell overhang requirement, a composite cathode frame assembly, a battery cell and an assembly method of the battery cell are provided in the disclosure.

The composite cathode frame assembly, the battery cell and the assembly method of the battery cell provided in the disclosure adopts following technical schemes.

In a first aspect, a composite cathode frame assembly is provided in the disclosure, which adopts a following technical scheme.

The composite cathode frame assembly includes a frame, a cathode sheet and a separator sheet. An accommodating groove for embedding the cathode sheet is provided in the frame, both surfaces of the frame are matched with the separator sheet, and the separator sheet is attached to a surface of the frame and covers the cathode sheet.

By adopting the technical scheme above, the frame is used as a carrier to carry the cathode sheet, and thus the frame can be regarded as an extension of a width and a length of the cathode sheet. In this way, as long as a peripheral dimension of the frame is set to be the same as or close to that of the anode sheet, it is very easy to align the frame and the anode sheet by positioning and correcting by the apparatus with a periphery of the frame as a positioning reference. At this time, because the cathode sheet is embedded in the frame, overhang effect can be achieved for the anode sheet over the cathode sheet. Furthermore, the protruding position of the pole lug fixes the cathode sheet to ensure that it will not deviate, and the Overhang size is guaranteed. Similarly, the separator sheet can also be combined with the frame in a same alignment way to achieve complete coverage of the cathode sheet.

To sum up, with the frame embedded-in system, not only an error rate of the “overhang” for the anode sheet over the cathode sheet can be greatly reduced or even completely eliminated, but also production difficulty can be reduced, so that it is easier to design a corresponding automatic alignment apparatus and realize automatic production.

Optionally, the separator sheet is attached to the surface of the frame and covers the cathode sheet and the frame.

Optionally, the frame includes two side bars, a top bar and a bottom bar. The top bar, the bottom bar and the side bars enclose to form the accommodating groove.

Optionally, if a minimum thickness of each of the side bars is a, a thickness of the cathode sheet is b, and an error value is c, then a=b+c, c∈(−1,1), with c in unit of mm.

By adopting the technical scheme above, a thickness of the cathode sheet is basically the same as or close to that of the frame, so that after the cathode sheet is embedded in the frame, protrusion or depression relative to the frame is small. In this way, when the separator sheet is attached to a surface of the frame, it can cover the cathode sheet more smoothly, the separator sheet itself is not easy to tilt, and correspondingly, the anode sheet is not easy to tilt when covering, which may cause covering deviation.

Optionally, the thickness of the cathode sheet may be greater than or equal to the minimum thickness of the side bar.

Alternatively, the top bar includes at least one thick part and at least one thin part which are connected with each other. An end of the cathode sheet is provided with a first tab, and a position of the thin part corresponds to a position of the first tab, and a sum of thicknesses of the first tab and the thin part is smaller than a thickness of the thick part, and the first tab can pass through the top bar at a position where the thin part is located.

By adopting the technical scheme above, on the one hand, the first tab can be placed outside the frame and can be electrically connected with the outside; and on the other hand, integrity of a surrounding structure of the frame can be maintained, so that the frame is not easy to deform during assembly; and on this basis, it is also ensured that the cathode sheet and a corresponding first tab are basically flush or nearly flush with the frame in a thickness direction.

Alternatively, there are at least two thick parts, the thin part is located between adjacent thick parts, a width of the thin part is smaller than those of the thick parts, the thin part and the adjacent thick parts enclose to form an embedding groove, and the embedding groove is communicated with the accommodating groove.

A part where the first tab is connected with the cathode sheet is often thick, and by adopting the technical scheme above, on a basis of ensuring the integrity of the surrounding structure of the frame, an accommodation space can be provided for the thick parts.

Alternatively, the thick part is provided with a rounded corner at an opening where the embedding groove is communicated with the accommodating groove.

By adopting the technical scheme above, when assembling, a thick part of the first tab abuts against the rounded corner, thus providing guidance and correction for overall positions of the first tab and the cathode sheet. Moreover, after embedding, the thick part of the first tab can form a stressed entirety with the top bar to compensate for strength loss of the thin rod.

Alternatively, an end of the cathode sheet is provided with a first tab, and a sum of thicknesses of the first tab and the top bar is smaller than a thickness of the side bar. That is to say, the sum of the thickness of the first tab and the thick part of the top bar can be set to be smaller than the thickness of the side bar.

By adopting the technical scheme above, the first tab can extend out at any part of the top bar, thus reducing accuracy requirement of this part.

Alternatively, a convex part is convexly provided at corners of the side bar and the bottom bar located in the accommodating groove respectively, and a concave part adapted to the convex part is provided at a corresponding part of the cathode sheet.

By adopting the technical scheme above, the convex part is constructed as a positioning identification point, so that the cathode sheet can be accurately installed in the accommodating cavity, in which a location identification model can be information-based, for example, using a sensor or the like to identify; or can be of a structural type, for example, a guide rod pointing to the convex part is built with reference to the convex part so that the cathode sheet can be guided into the accommodating groove by the guide rod.

Alternatively, a surface of the convex part at the accommodating groove is an arc surface, and corners of the side bar and the bottom bar away from the accommodating groove are concavely provided with a concave surface, and the concave surface also can be an arc surface.

By adopting the technical scheme above, when the sensor is adopted, such a structure with the arc surface can be more easily adapted to an emission landing point of the sensor; and when a rod-type guide is adopted, a surface of a rod-type structure can also be adapted to the arc surface, so that damage to the cathode sheet can be reduced in guiding.

In addition, the concave surface of the outer corner corresponds to the arc surface, which can provide a small elastic deformation space for the convex part, thus with a larger error compensation space between the cathode sheet and the frame.

Alternatively, a corner at a peripheral side of the separator sheet is provided with a groove, and a wall of the groove is flush with the concave surface.

By adopting the technical scheme above, a positioning identification point can be constructed outside the frame on a basis of the groove and the concave surface, and likewise, an identification mode can also be information-based or of a structural type, which can provide guidance for accurate alignment of the separator sheet and the anode sheet.

Alternatively, the convex part is provided with a guide surface and a positioning surface. The guide surface is a spherical surface and the positioning surface is an arc surface. After the cathode sheet is embedded in the accommodating groove, an inner wall of the concave part is attached to the positioning surface.

By adopting the technical scheme above, a function of the arc surface is the same as a function of the arc surface, and the spherical surface can function in guiding and correcting, so that position error during installation of the cathode sheet can be corrected; and the spherical surface can also be combined with the rounded corner of the embedding groove to jointly form overall guidance and deviation correction of the cathode sheet.

Alternatively, thicknesses of the top bar and the bottom bar are each smaller than that of the side bar, the separator sheet is embedded between the two side bars, and the separator sheet abuts against surfaces of the top bar, the bottom bar and the cathode sheet. In other embodiments, the thickness of the top bar and the bottom bar can also each be equal to the thickness of the side bar, and the separator sheet can be adhered to the two side bars, not necessarily to the top bar or the bottom bar, and the separator sheet can also be adhered to the two side bars, the top bar and the bottom bar together.

By adopting the technical scheme above, the separator sheet is matched with the frame in an embedding way, with more stable connection.

Alternatively, a surface of the frame is concavely provided with a clamping groove, the separator sheet is embedded in the clamping groove, the clamping groove and the accommodating groove form a stepped groove, and a projection of an inner wall of the clamping groove along a direction perpendicular to the surface of the cathode sheet surrounds an inner wall of the accommodating groove.

By adopting the technical scheme above, the separator sheet is matched with the frame in an embedding way, with more stable connection, and the separator sheet still completely covers the cathode sheet, so that the cathode sheet is fully isolated from the anode sheet.

Alternatively, the frame is made of an insulating material.

By adopting the technical scheme above, it is possible to avoid direct conduction between the cathode sheet and the anode sheet.

Alternatively, a connection relationship between the separator sheet and the frame is replaced by the following: the separator sheet is embedded in the accommodating groove and attached to the surface of the cathode sheet. The sum of the thickness of the cathode sheet and the thickness of the separator sheet≥the thickness of the outer edge of the frame. If the sum of the thickness of the cathode sheet and the thickness of the separator sheet is smaller than the thickness of the frame, there is a height difference between the cathode and the anode when forming the whole battery, which leads to the lithium ion escaping or the distance is too large when embedding, leading to the inability to charge and discharge.

Alternatively, the separator sheet can be made of elastic material, such as polymer material, and further it can be PP/PE material, etc. Therefore, even when the surface of the frame is recessed with the clamping groove and the separator sheet is embedded in the clamping groove, the sum of the thickness of the cathode sheet and the thickness of the separator sheet≥the thickness of the outer edge of the frame, the separator sheet can still cover or partially cover the frame. In other embodiments, the separator sheet may only cover the cathode sheet and not cover the frame.

When the thickness of the cathode sheet is greater than the minimum thickness of the side bar, because the separator sheet can be made of elastic material, it can tilt from the edge of the cathode sheet to the clamping groove. Or in other embodiments, the separator sheet can be provided with a flange which is matched with the clamping groove.

By adopting the technical scheme above, the separator sheet can be embedded into the accommodating groove and form a whole closed cathode sheet with the frame, and the surface of this entirety can be kept flat, which facilitates accurate matching of the anode sheet and the frame.

In a second aspect, a battery cell is provided in the disclosure, which adopts the following technical scheme.

The battery cell includes a composite cathode frame assembly, and further includes a packaging sleeve and an anode sheet. The anode sheet covers a surface of a separator sheet, and a projection of a peripheral side wall of the anode sheet along a direction perpendicular to a surface of the anode sheet overlaps with a peripheral side wall of the frame. A plurality of the composite cathode frame assemblies and a plurality of anode sheets are laminated to each other and staggered to form a unit body, and the packaging sleeve wraps a peripheral side wall of the unit body.

By adopting the technical scheme above, the anode sheet and the frame can be aligned quickly and accurately by an assembly apparatus abutting against a positioning structure at the peripheral side, so that complete covering of the anode sheet cover the cathode sheet can be ensured effectively. After the unit body is assembled, a combined battery cell can be formed by lamination and wrapping by the package sleeve.

In a third aspect, an assembly method of a battery cell can be provided in the disclosure, which adopts the following technical scheme.

The assembly method of a battery cell includes following steps: a, aligning and bonding a separator sheet to one surface of a frame; b, disposing a cathode sheet into an accommodating groove of the frame, and passing a first tab of the cathode sheet through an end of the frame; c, aligning and bonding a second separator sheet to the other surface of the frame; d, aligning the anode sheet to the frame and attaching the anode sheet to a surface of the second separator sheet, the anode sheet being provided with a second tab, and the first tab and the second tab being staggered in a thickness direction of the cathode sheet; and e, taking an assembled entirety above as a unit body, a plurality of unit bodies being laminated and wrapped by a package sleeve.

By adopting the technical scheme above, after the anode sheet is aligned with the frame, due to an inclusion relationship between the frame and the cathode sheet, overhang of the anode sheet over the cathode sheet can be realized for each battery cell, with an extremely small error rate.

To sum up, the disclosure includes at least one of following beneficial technical effects.

1. The frame is used as a carrier to carry the cathode sheet, and thus the frame can be regarded as an extension of a width and a length of the cathode sheet. In this way, as long as a peripheral dimension of the frame is set to be the same as or close to that of the anode sheet, it is very easy to align the frame and the anode sheet by positioning and correcting by the apparatus with a periphery of the frame as a positioning reference. At this time, because the cathode sheet is embedded in the frame, overhang effect can be achieved for the anode sheet over the cathode sheet. Similarly, the separator sheet can also be combined with the frame in a same alignment way to achieve complete coverage of the cathode sheet. With the frame embedded-in system, not only an error rate of the “overhang” for the anode sheet over the cathode sheet can be greatly reduced or even completely eliminated, but also production difficulty can be reduced, so that it is easier to design a corresponding automatic alignment apparatus and realize automatic production.

2. The convex part is constructed as the positioning identification point, so that the cathode sheet can be accurately installed in the accommodating cavity, in which a location identification model can be information-based, for example, using a sensor or the like to identify; or can be of a structural type, for example, a guide rod pointing to the convex part is built with reference to the convex part so that the cathode sheet can be guided into the accommodating groove by the guide rod.

### BRIEF DESCRIPTION OF THE DRAWINGS

FIG. 1 is an exploded view of a composite cathode frame assembly according to Embodiment 1.

FIG. 2 is an enlarged view at a part A of FIG. 1 according to Embodiment 1.

FIG. 3 is an enlarged view at a part B of FIG. 1 according to Embodiment 1.

FIG. 4 is a schematic structural diagram of a composite cathode frame assembly according to Embodiment 2.

FIG. 5 is an overall structural diagram of a frame according to Embodiment 3.

FIG. 6 is an enlarged view at a part C of FIG. 5 according to Embodiment 3.

FIG. 7 is a schematic structural diagram of a composite cathode frame assembly according to Embodiment 4.

FIG. 8 is an overall structural diagram of a frame according to Embodiment 5.

FIG. 9 is a schematic structural diagram of a composite cathode frame assembly according to Embodiment 6.

FIG. 10 is an overall structural diagram of a battery cell according to Embodiment 7.

FIG. 11 is an exploded view of a battery cell according to Embodiment 7.

Reference numerals: 1. Frame; 11. Side Bar; 12, Top Bar; 121, Thick Part; 122, Thin Part; 123, Embedding Groove; 124, Through Groove; 13. Bottom Bar; 14. Accommodating Groove; 15. Convex Part; 151, Guide Surface; 152, Positioning Surface; 16. Concave Surface; 17. Clamping Groove; 2. Cathode Sheet; 21. First Tab; 22. Concave Part; 3. Separator Sheet; 31, Groove; 4. Anode Sheet; 41. Anode Groove; 42. Second Tab; 5, Package Sleeve; 10. Composite Cathode Frame Assembly.

### DETAILED DESCRIPTION

In the following, the present disclosure will be further described in detail with reference to the drawings.

A composite cathode frame assembly, a battery cell and an assembly method of the battery cell are provided in the disclosure.

### Embodiment 1

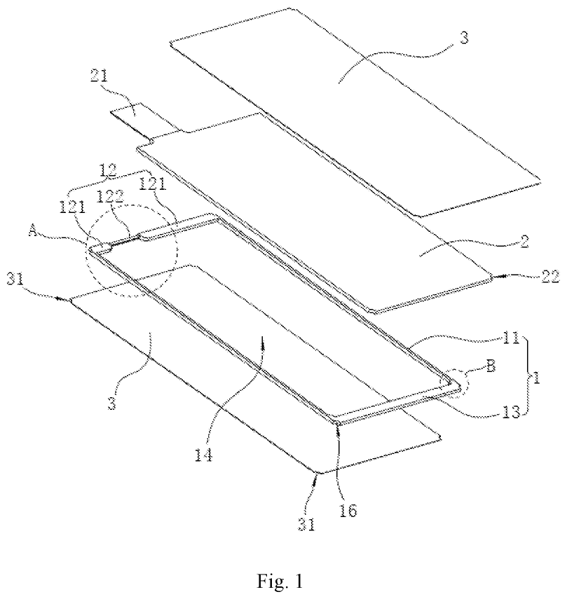

Referring to FIG. 1, a composite cathode frame assembly includes a frame 1, a cathode sheet 2 and a separator sheet 3.

The frame 1 is made of an insulating material, which can be an inorganic material, such as ceramics, alumina, zirconia, titanium oxide, etc., or an organic material, such as PP, PVC, PE, PET, PI, etc., or an inorganic-organic composite material.

The frame 1 includes two side bars 11, a top bar 12 and a bottom bar 13. The top bar 12, the bottom bar 13 and the side bars 11 enclose to form an accommodating groove 14, and the cathode sheet 2 can be tightly embedded in the accommodating groove 14. It should be noted that bars mentioned in this application is not limited to straight bars, and the bars with radians, bendings and so on should be regarded to be within a protection scope of this application, and a cross-section of the bar can be of a circular shape, a polygonal shape or a combination thereof. The straight bars are taken as an example for the bars in this embodiment.

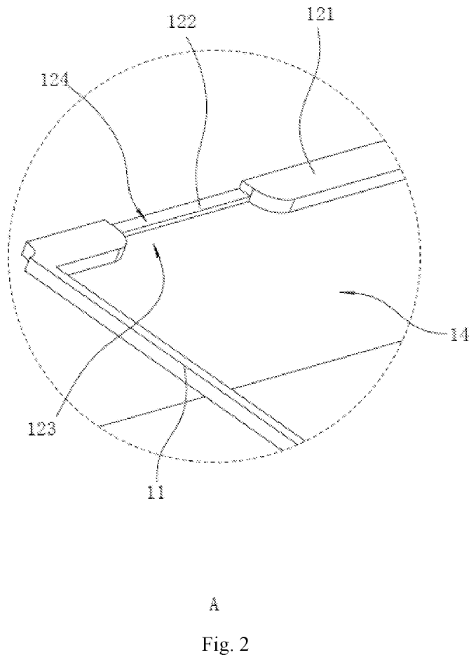

Referring to FIGS. 1 and 2, the top bar 12 includes at least one thick part 121 and at least one thin part 122 which are connected with each other. In this embodiment, there are two thick parts 121 and one thin part 122, and both ends of the thin part 122 are respectively connected with one thick part 121, and the two thick parts 121 are respectively connected with one side bar 11. A thickness and width of the thin part 122 are smaller than those of the thick parts 121. In this way, at a side of the thin part 122 facing the accommodating groove 14, the thin part 122 and the thick part 121 enclose to form an embedding groove 123, and the embedding groove 123 is communicated with the accommodating groove 14, and ends of the thick parts 121 at an opening of the embedding groove 123 are provided with a rounded corner. At a side of the thin part 122 in a thickness direction, the thin part 122 and the thick parts 121 enclose to form a through groove 124, and the through groove 124 is also communicated with the accommodating groove 14, the opening of the through groove 124 is disposed towards the cathode sheet 2.

In terms of definition of the thickness, the cathode sheet 2 is of a thin sheet structure, and the thickness direction in this embodiment is referred based on the thickness of the cathode sheet 2.

A first tab 21 is provided at an end of the cathode tab 2. A part of the first tab 21 connected to the cathode sheet 2 is a root of the first tab 21, the root of the first tab 21 is thicker than other parts of the first tab 21. During assembly, the cathode sheet 2 is embedded in the accommodating groove 14, and the root of the first tab 21 is embedded in the embedding groove 123 through guidance and rectification by the rounded corner, and the first tab 21 passes through the through groove 124 and is exposed outside the frame 1.

For a thickness relationship between cathode sheet 2 and frame 1, the side bar 11 is relatively complete as a whole, and a thickness of the side bar 11 represents a thickness of frame 1. Let a minimum thickness of side bar 11 be a, a thickness of cathode sheet 2 be b, and an error value be c, then a=b+c, c∈(−1,1), with c in unit of mm. In this embodiment, a value of c is 0, and a thickness of the thick part 121 is the same as the thickness of the side bar 11, and a sum of thicknesses of the first tab 21 and the thin part 122 is smaller than the thickness of the thick part 121.

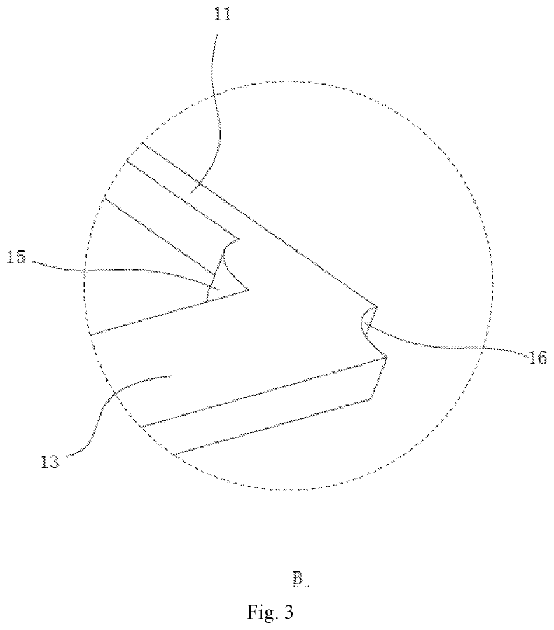

Referring to FIGS. 1 and 3, two corners of the side bar 11 and the bottom bar 13 located in the accommodating groove 14 are both provided with a convex part 15, and an surface of the convex part 15 located in the accommodating groove 14 is an arc surface. A concave part 22 adapted to the convex part 15 is provided at a corresponding part of the cathode sheet 2. In this way, by combining the groove 123 and the two protrusions 15, a three-point position can be made between the cathode sheet 2 and the frame 1. Moreover, the two convex parts 15 are also very easy to be adapted to a positioning guide structure provided in a production apparatus for accurate assembling. For example, an apparatus for grasping the cathode sheet 2 can detect a position of the concave part 22 with a sensor to determine accuracy of a grasping position of the cathode sheet 2, and then detect a position of the convex part 15 by the sensor passing through the concave part 22 to determine alignment accuracy of the cathode sheet 2 and the accommodating groove 14, so as to accurately place the cathode sheet 2 into the accommodating groove 14.

Correspondingly, a corner of the frame 1 away from the accommodating groove 14 is concavely provided with a concave surface 16, and the concave surface 16 is also an arc surface. The concave surface 16 corresponds to the convex portion 15, so that the convex portion 15 can be with a small elastic deformation, so as to expand an allowable error threshold between the convex portion 15 and the concave part 22 and reduce alignment difficulty.

Both surfaces of the frame 1 are matched with the separator sheet 3, and the separator sheet 3 is attached to a surface of the frame 1 and covers the cathode 2 and the frame 1. A corner at a peripheral side of the separator sheet 3 is provided with a groove 31, and a wall of the groove 31 is flush with the concave surface 16. The groove 31 and the concave surface 16 can also serve as a positioning reference of the separator sheet 3 and the frame 1, with a positioning mode being a positioning mode of the cathode 2 described above. A mechanical positioning mode can also be applied outside the frame 1, for example, an extrusion manipulator that can cooperate with the concave surface 16 is applied around the frame 1. For example, the cooperated concave surface 16 is provided with two guide rods, and the separator sheet 3 lies on the surface of the frame 1 along the guide rods.

In terms of connection between the separator sheet 3 and the frame 1, bonding, blanching or ultrasonic welding can be adopted.

### Embodiment 2

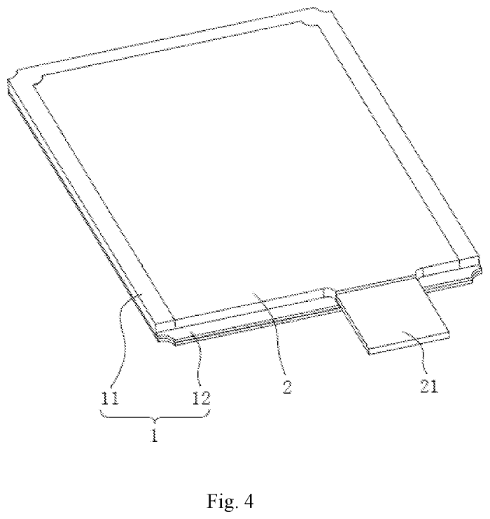

Referring to FIG. 4, this embodiment is different from Embodiment 1 in that an overall thickness of the top bar 12 is smaller than that of the side bar 11, and a sum of thicknesses of the first tab 21 and the top bar 12 is smaller than a thickness of the side bar 11.

### Embodiment 3

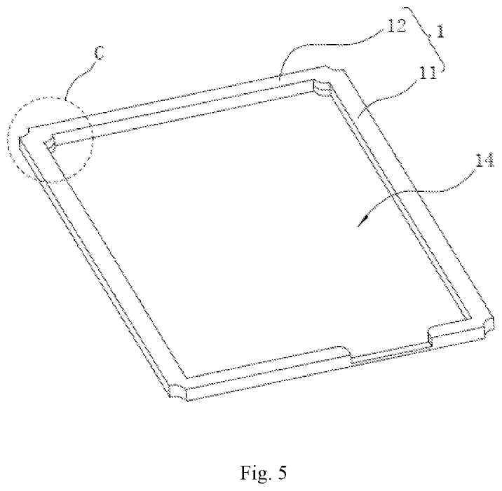

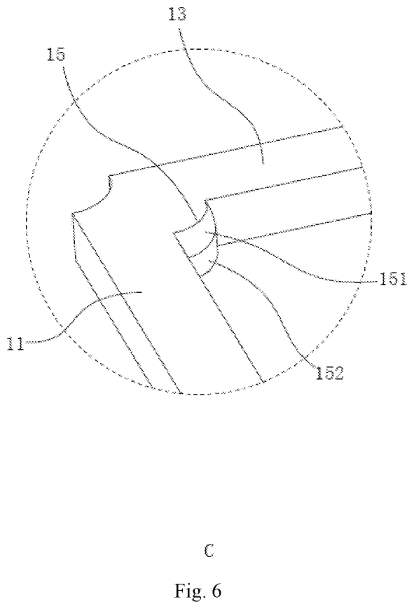

Referring to FIGS. 5 and 6, this embodiment is different from Embodiment 1 in that the convex part 15 has a guide surface 151 and a positioning surface 152, and the guide surface 151 is located on a side where the cathode sheet 2 firstly passes through when it is loaded into the accommodating groove 14, the guide surface 151 is a spherical surface and the positioning surface 152 is an arc surface. After the cathode sheet 2 is embedded into the accommodating groove 14, an inner wall of the concave part 22 is attached to the positioning surface 152. The spherical surface can function in rectifying deviation and guiding the cathode sheet 2 which is to be placed into the accommodating groove 14.

### Embodiment 4

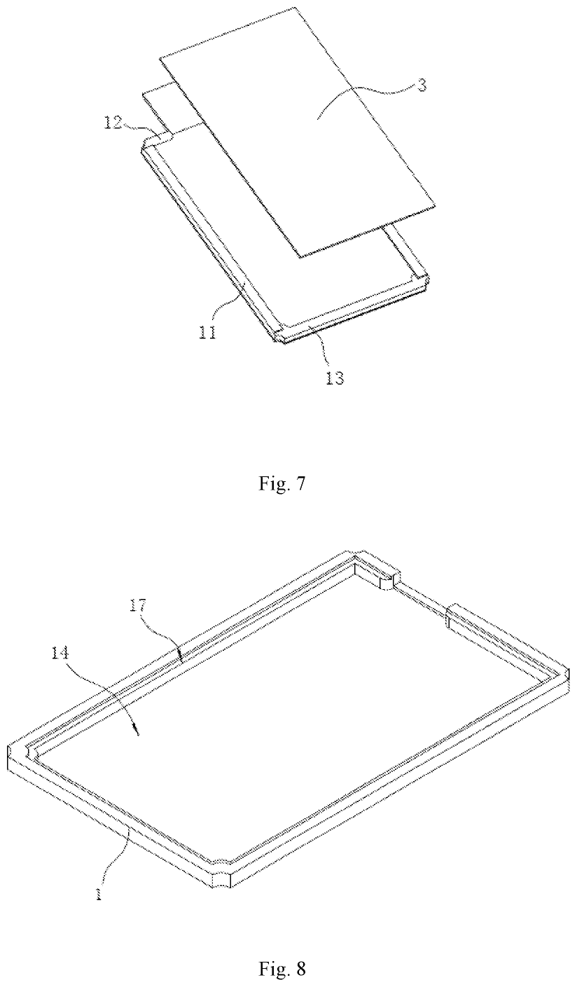

Referring to FIG. 7, this embodiment is different from Embodiment 1 in that the thicknesses of the top bar 12 and the bottom bar 13 are both smaller than the thicknesses of the side bars 11, and the separator sheet 3 is embedded between the two side bars 11, and abuts against surfaces of the top bar 12, the bottom bar 13 and the cathode sheet 2.

### Embodiment 5

Referring to FIG. 8, this embodiment is different from Embodiment 1 in that the surface of the frame 1 is concavely provided with a clamping groove 17, the clamping groove 17 and the accommodating groove 14 form a stepped groove, and a projection of an inner wall of the clamping groove 17 along a direction perpendicular to the surface of the cathode sheet 2 surrounds an inner wall of the accommodating groove 14. The separator sheet 3 (not shown) is embedded in the clamping groove 17.

### Embodiment 6

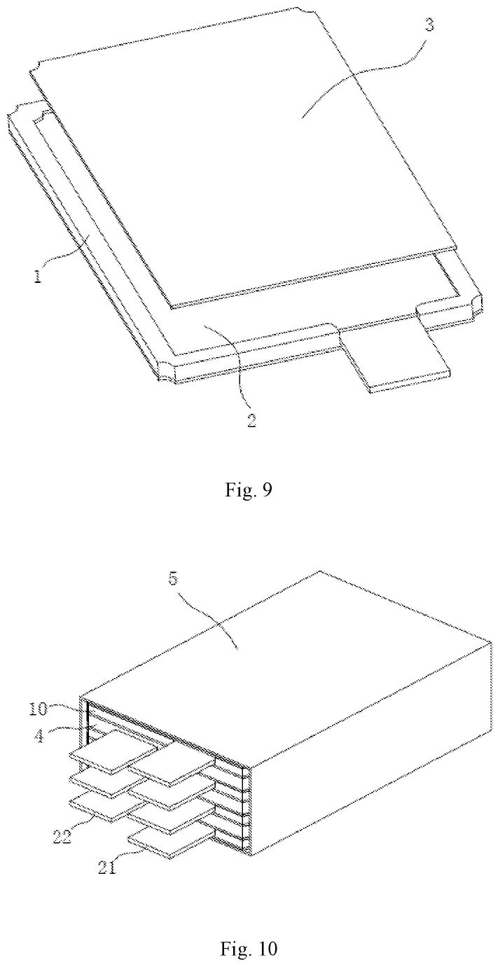

Referring to FIG. 9, this embodiment is different from Embodiment 1 in that a connection relationship between the separator sheet 3 and the frame 1 is replaced by the following: the separator sheet 3 is embedded in the accommodating groove 14 and attached to the surface of the cathode sheet 2, and a sum of the thicknesses of the cathode sheet 2 and the separator sheet 3 is equal to a thickness of the frame 1.

### Embodiment 7

Referring to FIG. 10, a battery cell includes a composite cathode frame assembly 10 of any one of Embodiments 1 to 3, as well as a package sleeve 5 and an anode sheet 4. The anode sheet 4 covers a surface of the separator sheet 3, and a peripheral corner of the anode sheet 4 is provided with an anode groove 41 aligned with the groove 31 of the separator. The anode sheet 4 can be assembled in a same precise alignment manner as the separator sheet 3. A projection of a peripheral side wall of the anode sheet 4 along a direction perpendicular to a surface of the anode sheet 4 overlaps with a peripheral side wall of the frame 1. A plurality of the composite cathode frame assemblies 10 and a plurality of anode sheets 4 are laminated to each other and staggered to form a unit body, and specific numbers of composite cathode frame assemblies 10 and anode sheets 4 is adjusted according to actual parameters of the battery cell. The packaging sleeve 5 wraps a peripheral side wall of the unit body.

### Embodiment 8

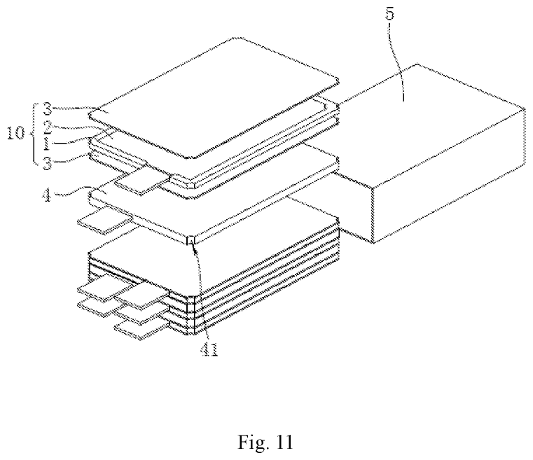

Referring to FIG. 1 and FIG. 11, an assembling method of a battery cell includes following steps: a, aligning and bonding a separator sheet 3 to one surface of a frame 1; b, disposing a cathode sheet 2 into an accommodating groove 14 of the frame 1, and passing a first tab 21 of the cathode sheet 2 through an end of the frame 1; c, aligning and bonding a second separator sheet 3 to the other surface of the frame 1; d, aligning the anode sheet 4 to the frame 1 and attaching the anode sheet to a surface of the second separator sheet 3, the anode sheet 4 being provided with a second tab 42, and the first tab 21 and the second tab 42 being staggered in a thickness direction of the cathode sheet 2; and e, laminating and staggering a plurality of composite cathode frame assemblies 10 and a plurality of anode sheets 4 to form a unit body, the unit body being wrapped by a packaging sleeve 5.

The above are preferred embodiments of this disclosure, but do not limit a protection scope of this disclosure accordingly. Therefore, all equivalent changes made according to structures, shapes and principle of this disclosure should be encompassed in the protection scope of this disclosure.

What is claimed is:

1. A composite cathode frame assembly, comprising a frame, a cathode sheet and a separator sheet, wherein an accommodating groove for embedding the cathode sheet is provided in the frame, both sides of the frame are provided with the separator sheet, namely a first separator sheet, and a second separator sheet, the first separator sheet is attached to one side of the frame, and the second separator sheet is attached to the other side of the frame and covers the cathode sheet.

2. The composite cathode frame assembly according to claim 1, wherein the frame comprises two side bars, a top bar and a bottom bar, and the top bar, the bottom bar and the two side bars enclose to form the accommodating groove.

3. The composite cathode frame assembly according to claim 2, wherein the top bar comprises at least one thick part and at least one thin part which are connected with each other, an end of the cathode sheet being provided with a first tab, and a position of the thin part corresponding to a position of the first tab, and a sum of thicknesses of the first tab and the thin part being smaller than a thickness of the thick part, and the first tab being capable of passing through the top bar at a position where the thin part is located.

4. The composite cathode frame assembly according to claim 3, wherein there are at least two thick parts, the thin part are located between adjacent two thick parts, a width of the thin part is smaller than widths of the adjacent two thick parts, so that the thin part and the adjacent two thick parts enclose to form an embedding groove, and the embedding groove is communicated with the accommodating groove.

5. The composite cathode frame assembly according to claim 4, wherein the at least one thick part is provided with a rounded corner at an opening where the embedding groove is communicated with the accommodating groove.

6. The composite cathode frame assembly according to claim 2, wherein an end of the cathode sheet is provided with a first tab, and a sum of thicknesses of the first tab and the top bar is smaller than a thickness of each side bar.

7. The composite cathode frame assembly according to claim 2, wherein a convex part is convexly provided at corners of one or two side bar and the bottom bar located in the accommodating groove respectively, and a concave part adapted to the convex part is provided at a corresponding part of the cathode sheet.

8. The composite cathode frame assembly according to claim 7, wherein a surface of the convex part at the accommodating groove is an arc surface, and corners of one or two side bar and the bottom bar away from the accommodating groove are concavely provided with a concave surface, and the concave surface is also an arc surface.

9. The composite cathode frame assembly according to claim 8, wherein a corner at a peripheral side of the first separator sheet and/or the second separator sheet is provided with a groove, and a wall of the groove is flush with the concave surface.

10. The composite cathode frame assembly according to claim 7, wherein the convex part is provided with a guide surface and a positioning surface, the guide surface being a spherical surface and the positioning surface being an arc surface; and after the cathode sheet is embedded in the accommodating groove, an inner wall of the concave part is attached to the positioning surface.

11. The composite cathode frame assembly according to claim 2, wherein thicknesses of the top bar and the bottom bar are each smaller than a thickness of the side bar, the separator sheet is embedded between the two side bars, and the separator sheet abuts against surfaces of the top bar, the bottom bar and the cathode sheet.

12. The composite cathode frame assembly according to claim 1, wherein a surface of the frame is concavely provided with a clamping groove, the second separator sheet is embedded in the clamping groove, the clamping groove and the accommodating groove form a stepped groove, and a projection of an inner wall of the clamping groove along a direction perpendicular to a surface of the cathode sheet surrounds an inner wall of the accommodating groove.

13. The composite cathode frame assembly according to claim 1, wherein the frame is made of an insulating material.

14. The composite cathode frame assembly according to claim 1, wherein a connection relationship between the second separator sheet and the frame is replaced by the following: the second separator sheet is embedded in the accommodating groove and attached to a surface of the cathode sheet.

15. An battery cell, comprising the composite cathode frame assembly according to claim 1, and further comprising a packaging sleeve and an anode sheet, wherein the anode sheet covers a surface of the second separator sheet, and a projection of a peripheral side wall of the anode sheet along a direction perpendicular to a surface of the anode sheet overlaps with a peripheral side wall of the frame; a plurality of the composite cathode frame assemblies and a plurality of anode sheets are laminated to each other and staggered to form a unit body; and the packaging sleeve wraps a peripheral side wall of the unit body.

16. An assembly method of the battery cell according to claim 15, comprising following steps:
a) aligning and bonding the first separator sheet to one side of a frame;
b) disposing a cathode sheet into an accommodating groove of the frame, and passing a first tab of the cathode sheet through an end of the frame;
c) aligning and bonding the second separator sheet to the other side of the frame;
d) aligning the anode sheet to the frame and attaching the anode sheet to a surface of the second separator sheet, the anode sheet being provided with a second tab, and the first tab and the second tab being staggered in a thickness direction of the cathode sheet; and
e) taking an assembled entirety above as a unit body, a plurality of unit bodies being laminated and wrapped by a package sleeve.
